(19) United States
(12) Patent Application Publication
(10) Pub. No.: US 2013/0039172 A1
(43) Pub. Date: Feb. 14, 2013

(54) COMMUNICATION APPARATUS, COMMUNICATION METHOD, AND COMPUTER PRODUCT

(71) Applicant: Nobutaka IMAMURA, Kawasaki (JP)

(72) Inventor: Nobutaka IMAMURA, Kawasaki (JP)

(73) Assignee: FUJITSU LIMITED, Kawasaki-shi (JP)

(21) Appl. No.: 13/495,034

(22) Filed: Jun. 13, 2012

(30) Foreign Application Priority Data
Aug. 11, 2011 (JP) 2011-176423

(51) Int. Cl. H04L 12/26

(52) U.S. Cl. 370/229

(57) ABSTRACT

A communication apparatus communicates with multiple sources and includes an interface that receives from a given source among the sources, information indicating a data volume of source data that is at the given source and to be acquired by the communication apparatus as an executor; and a processor that based on the received information, judges whether the given source is to be an acquisition target, and acquires from the given source that has been judged to be an acquisition target, the source data to be acquired by the communication apparatus.

### CROSS REFERENCE TO RELATED APPLICATIONS

This application is based upon and claims the benefit of priority of the prior Japanese Patent Application No. 2011-176423, filed on Aug. 11, 2011, the entire contents of which are incorporated herein by reference.

### FIELD

The embodiment discussed herein is related to a communication apparatus, a communication method, and computer product that perform communication.

### BACKGROUND

In processing fields that use distributed parallel computers such as clusters, a communication counterpart may communicate a large volume of messages in the course of processing. When this occurs, message communication may concentrate temporarily at a portion of the communication apparatuses, whereby data collision occurs on the network, resulting in network congestion.

According to a conventional technology, a transmission right called a token, circulates on a network and only the communication apparatus that has received the circulating token transmits a message, thereby controlling the volume of communication on the network and preventing the collision of messages (see, for example, Japanese Laid-Open Patent Publication No. H04-070235).

Further, a technology changes the number of tokens to be circulated on a network, according to the number of communication apparatuses on the network (see, for example, Japanese Laid-Open Patent Publication No. 2000-332803). A further technology discontinues the transmission of messages until processing at a communication apparatus, where message communication has concentrated, has stabilized (see, for example, Japanese Patent No. 4343119).

Nonetheless, the technologies above do not consider the volume of unsent messages at the respective communication apparatuses. Consequently, a transmission right may be given to a communication apparatus having a smaller volume of unsent messages before a communication apparatus having a large volume of unsent messages and warranting priority to perform transmission. In this case, a problem arises in that at the communication apparatus, memory in the buffer storing unsent messages may become insufficient. Further, the transmission right may be given to a communication apparatus that has waited to receive the transmission right for less time than another communication that has waited a longer time. In this case, during communication, the message transmission deadline may be missed, resulting in processing delays and/or processing error.

### SUMMARY

According to an aspect of an embodiment, a communication apparatus communicates with multiple sources and includes an interface that receives from a given source among the sources, information indicating a data volume of source data that is at the given source and to be acquired by the communication apparatus as an executor; and a processor that based on the received information, judges whether the given source is to be an acquisition target, and acquires from the given source that has been judged to be an acquisition target, the source data to be acquired by the communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1 and 2 are diagrams of communication by a communication apparatus.

FIG. 3 is a block diagram of an example of a hardware configuration of a communication apparatus N according to an embodiment.

FIG. 4 is a diagram depicting the contents of a source acquired length log stored in a RAM 303 depicted in FIG. 3.

FIG. 5 is a diagram depicting the contents of a generation log stored in the RAM 303 depicted in FIG. 3.

FIG. 6 is a diagram depicting the contents of a request token latency log stored in the RAM 303 depicted in FIG. 3.

FIG. 7 is a diagram depicting the contents of a source acquisition throughput log stored in the RAM 303 depicted in FIG. 3.

FIG. 8 is a diagram depicting the contents of an acquired length log stored in the RAM 303 depicted in FIG. 3.

FIG. 9 is a diagram depicting the contents of an acquisition throughput log stored in the RAM 303 depicted in FIG. 3.

FIG. 10 is a diagram depicting the contents of a request token list stored in the RAM 303 depicted in FIG. 3.

FIG. 11 is a diagram depicting the contents of a communication counterpart list stored in the RAM 303 depicted in FIG. 3.

FIG. 12 is a diagram depicting acquisition conditions stored in the RAM 303 depicted in FIG. 3.

FIG. 13 is a diagram depicting the contents of a acquisition request list stored in the RAM 303 depicted in FIG. 3.

FIG. 14 is a block diagram of a functional configuration of the communication apparatus N as an executor that acquires message M.

FIG. 15 is a block diagram of a functional configuration of the communication apparatus N as a source of message M.

FIG. 16 is a flowchart of initialization processing.

FIG. 17 is a flowchart of application-use registration processing.

FIG. 18 is a diagram of request token transmission.

FIG. 19 is a flowchart of the buffer management processing.

FIG. 20 is a flowchart of request token transmission processing.

FIG. 21 is a diagram of the acquisition of message M by an executor communication apparatus N that has received a request token.

FIG. 22 is a diagram of message M acquisition based on a request token that includes the buffering volume for another executor.

FIG. 23 is a flowchart of acquisition request registration processing.

FIG. 24 is a flowchart of acquisition processing.

FIG. 25 is a diagram depicting changes of an acquisition condition table 1200.

### DESCRIPTION OF EMBODIMENTS

Preferred embodiments of the present invention will be explained with reference to the accompanying drawings. A communication apparatus according to the present invention has a function of directly acquiring data from a storage device of another communication device via remote direct memory access (RDMA) transfer. Further, the communication apparatus buffers for each executor communication apparatus, source data that is acquired by the executor communication apparatuses.

Here, to control the volume of data on the network and to suppress congestion, source communication apparatuses from which data is acquired, notify an executor communication apparatus of information indicating the volume of data buffered. The executor communication apparatus receives the information indicating the volume of data buffered at each source communication apparatus and thereby knows the volume of data buffered at each source communication apparatus.

The executor communication apparatus gives priority (as an acquisition target) to a source communication apparatus whose buffer is under relatively more pressure and acquires source data from the source communication apparatus to an extent that does not cause network congestion. Consequently, exhaustion of the buffer can be avoided, the volume of data on the network can be controlled, collisions can be avoided, and network congestion can be suppressed. Furthermore, the throughput of the entire network can be improved, not just that between communication apparatuses, one-to-one. Since source data is buffered for each executor communication apparatus, throughput can be improved.

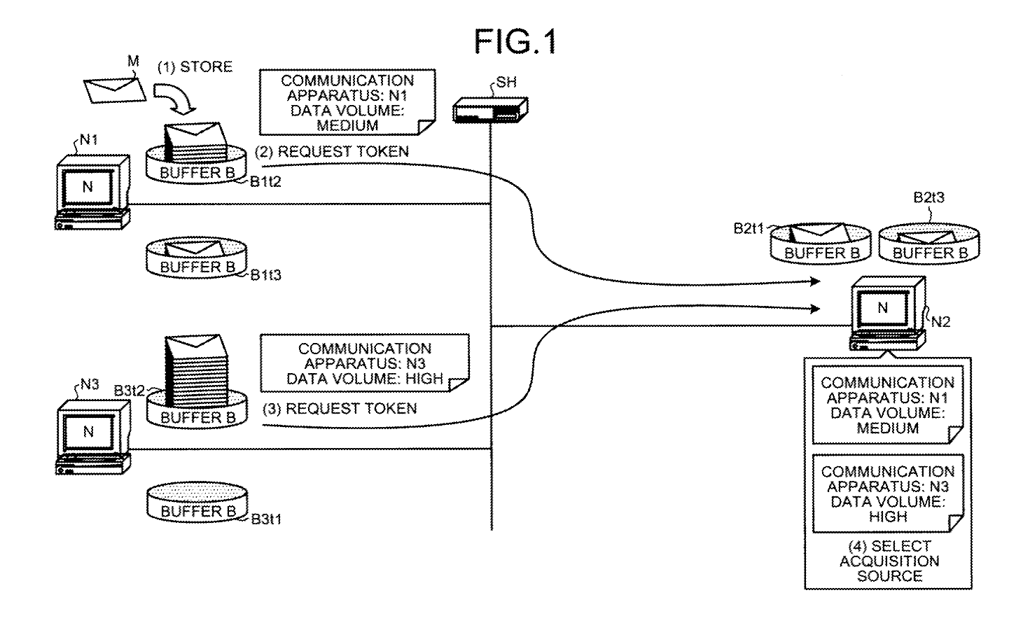

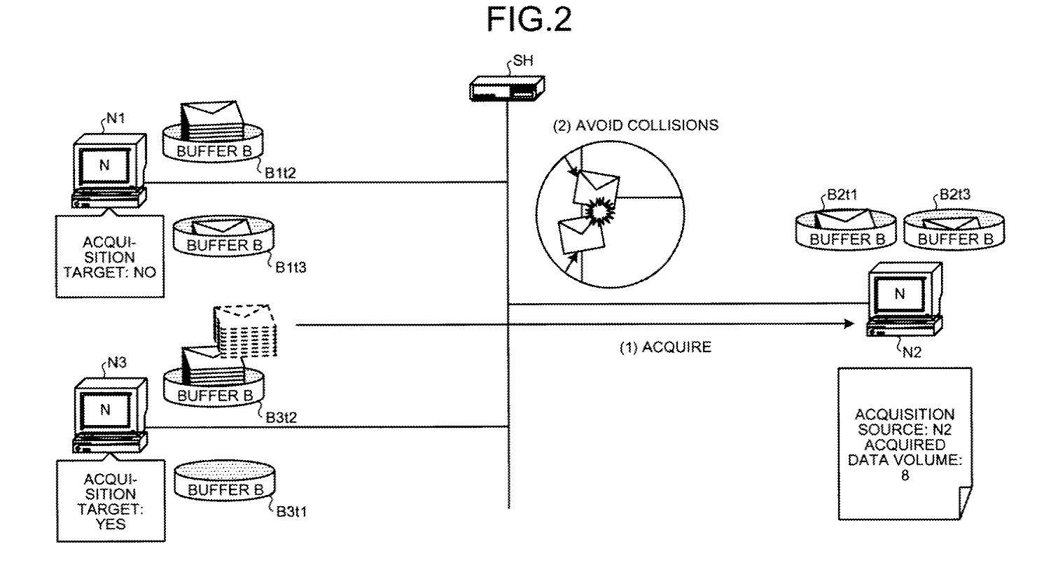

FIGS. 1 and 2 are diagrams of communication by the communication apparatus. Here, a communication system depicted in FIGS. 1 and 2 is a system of multiple communication apparatuses N (in FIGS. 1 and 2, for example, 3 communication apparatuses N1 to N3) connected via a network. The communication system communicates message M and includes a switching hub SH, which is a device that performs interrupts on the network.

Each communication apparatus N is an apparatus that can directly acquire message M of another communication apparatus N. Further, each communication apparatus N has for each executor communication apparatus N, a buffer B that buffers message M (source data), which is acquired by the executor communication apparatuses N that execute acquisition of message M. Message M is generated by applications executed by the respective communication apparatuses N.

For example, the communication apparatus N1 has buffer B1t2 that buffers message M acquired by the communication apparatus N2 and buffer B1t3 that buffers message M acquired by the communication apparatus N3.

The communication apparatus N2 has buffer B2t1 that buffers message M acquired by the communication apparatus N1 and buffer B2t3 that buffers message M acquired by the communication apparatus N3.

The communication apparatus N3 has buffer B3t1 that buffers message M acquired by the communication apparatus N1 and buffer B3t2 buffering message M acquired by the communication apparatus N2.

Hereinafter, an example of communication will be described where the communication apparatuses N1, N3 respectively request the communication apparatus N2 to acquire message M buffered by the communication apparatuses N1, N3 respectively.

In FIG. 1, (1) for each generation of message M that is to be acquired by the communication apparatus N2, the communication apparatus N1 stores the generated message M to the buffer B1t2. Similarly, the communication apparatus N3 stores to the buffer B3t2, message M that is to be acquired by the communication apparatus N2.

(2) To have the communication apparatus N2 acquire message M stored to the buffer B1t2, the communication apparatus N1 transmits to the communication apparatus N2, a request notification (hereinafter, “request token”) requesting acquisition of message M. The communication apparatus N1 waits for the acquisition of message M by the communication apparatus N2. Here, the request token stores therein an identifier of the communication apparatus N1 from which message M is to be acquired and the data volume of message M stored in the buffer B1t2. The data volume of message M stored in the buffer B1t2 is information that serves as an index of the pressure on the buffer B1t2.

(3) Similarly, to have the communication apparatus N2 acquire message M stored to the buffer B3t2, the communication apparatus N3 transmits a request token to the communication apparatus N2 and waits for the acquisition of message M by the communication apparatus N. Here, the request token includes an identifier of the communication apparatus N3 from which message M is to be acquired and the data volume of message M stored in the buffer B3t2. The data volume of message M stored in the buffer B3t2 is information that serves as an index of the pressure on buffer B3t2.

(4) The communication apparatus N2 that has received the respective request tokens from the communication apparatuses N1, N3 refers to the data volumes of message M stored in the respective buffers B of the communication apparatuses N1, N3 (the data volumes being indicated in the request tokens, respectively) and selects a communication apparatus N1, N3 from which to acquire message M. Here, the communication apparatus N2 gives priority to the communication apparatus N3 having a large data volume of message M stored to the buffer B, regards the communication apparatus N3 as the acquisition target, and determines that message M is to be acquired from the communication apparatus N3 before the buffer B becomes exhausted.

In FIG. 2, (1) the communication apparatus N2 refers to network throughput and to an extent that does not put pressure on the network, determines the volume (acquisition volume) of message M to be acquired from the communication apparatus N3, which is regarded as the acquisition target. The communication apparatus N2 acquires from the communication apparatus N3 regarded as the acquisition target, message M of the determined acquisition volume. Meanwhile, the communication apparatus N2 does not yet acquire message M from the communication apparatus N1.

(2) As a result, the data volume of message M on the network is controlled, enabling collisions of message M to be avoided. Consequently, congestion caused by collisions of message M can be suppressed. Further, since congestion can be suppressed, increases in communication time caused by congestion can be avoided and the communication phase of the network overall can be shortened.

By buffering message M at each communication apparatus N, network throughput can be improved. An executor communication apparatus N knows the data volume of message M stored in the respective buffers B of the source communication apparatuses N and acquires message M such that the buffers B are not subject to pressure. Consequently, the network can be used efficiently and the throughput of the network overall can be improved.

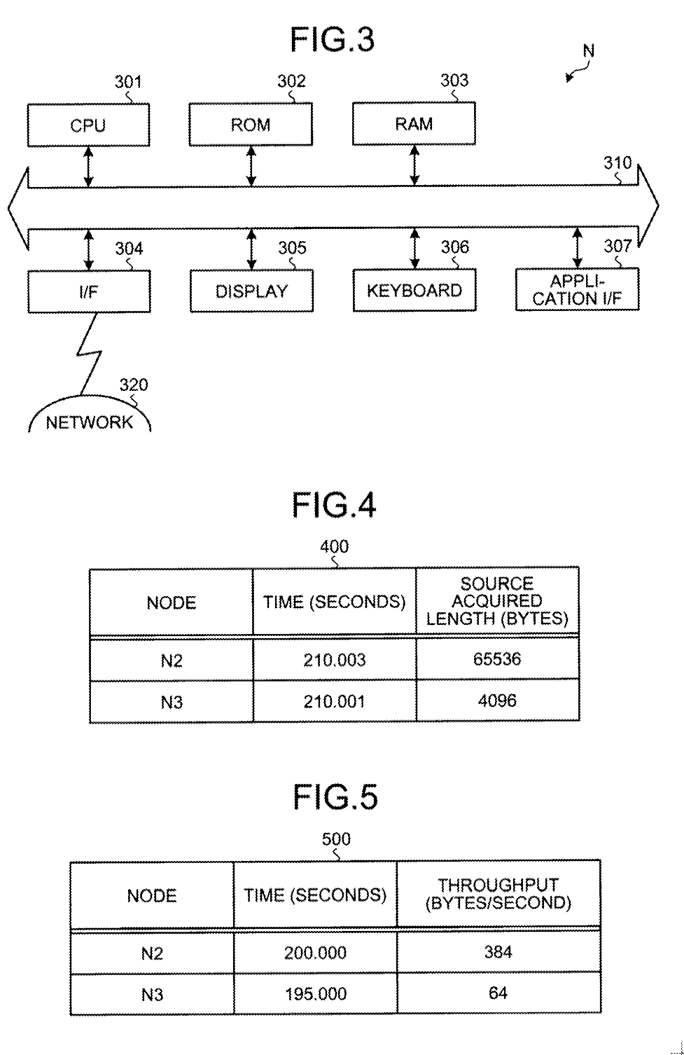

FIG. 3 is a block diagram of an example of a hardware configuration of the communication apparatus N according to an embodiment. In FIG. 3, the communication apparatus N includes a central processing unit (CPU) 301, a read-only memory (ROM) 302, a random access memory (RAM) 303, and interface (I/F) 304, a display 305, a keyboard 306, and an application I/F 307, respectively connected by a bus 310.

The CPU 301 governs overall control of the communication apparatus N. The ROM 302 stores therein programs such as a boot program. The RAM 303 is used as a work area of the CPU 301.

The RAM 303 is used as an area of the buffer B in each of the executor communication apparatuses N. The RAM 303 stores therein a source acquired length log, a generation log, a request token latency log, and a source acquisition throughput log. The RAM 303 further stores therein an acquired length log, an acquisition throughput log, and a request token list. The RAM 303 further stores therein a communication counterpart list, an acquisition condition table, and an acquisition request list.

The I/F 304 is connected to a network 320 such as a local area network (LAN), a wide area network (WAN), and the Internet through a communication line, and via the network 320 is connected to other apparatuses.

The I/F 304 administers an internal interface with the network 320 and exchanges data with other apparatuses by RDMA transfer. The I/F 304 directly writes to or reads out data with respect to a storage area of another apparatus by RDMA transfer. A modem or a LAN adaptor may be employed as the I/F 304. For example, when the network 320 is “Infini Band”, a host channel adapter (HCA) is adopted as the I/F 304.

With “Infini Band”, a queue pair (QP) that processes data transfers is held in the HCA. Here, a QP is an addressable entity formed by a transmission queue and a reception queue, and exists for each source communication apparatus N. “Infini Band” communication is performed between QPs and not ports. For example, an executor communication apparatus N, by queuing a series of instructions in a work queue, causes execution of the instructions in the HCA and performs data transfer.

The display 305 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 305. The keyboard 306 includes, for example, keys for inputting letters, numerals, and various instructions and performs the input of data. Alternatively, a touch-panel-type input pad or numeric keypad, etc. may be adopted.

The application I/F 307 controls the input and output of data from an application. For example, the application I/F 307 stores to the buffer B (the RAM 303) data generated by an application; passes to an application, data acquired from an external apparatus by the I/F 304; etc.

With reference to FIG. 4, the contents of the source acquired length log stored in the RAM 303 depicted in FIG. 3 will be described. The source acquired length log is a log concerning the data volume of message M acquired from a given communication apparatus N by another communication apparatus N.

FIG. 4 is a diagram depicting the contents of the source acquired length log stored in the RAM 303 depicted in FIG. 3. A source acquired length log 400 has a node field and a source acquired length, respectively associated with a time field, forming a record for each message M acquisition.

The time field stores therein the time (seconds) when message M was acquired. The node field stores therein the identifier of the executor communication apparatus N that acquired message M. The source acquired length field stores therein the acquired message M data volume (bytes).

With reference to FIG. 5, the contents of the generation log stored in the RAM 303 depicted in FIG. 3 will be described. The generation log is a log concerning the generation rate of message M (the rate at which message M is stored to buffer B) by an application in the given communication apparatus. The source communication apparatus N refers to the generation log thereof when determining when to transmit a request token to have an executor communication apparatus N acquire message M before the buffer B becomes exhausted.

FIG. 5 is a diagram depicting the contents of the generation log stored in the RAM 303 depicted in FIG. 3. A generation log 500 has a node field and throughput field, respectively associated with a time field, forming a record for each generation of message M by an application.

The time field stores therein the time (seconds) when message M was generated. The node field stores therein the identifier of the executor communication apparatus N that acquires the generated message M. The throughput field stores therein the message M data volume generated per unit time (bytes/second).

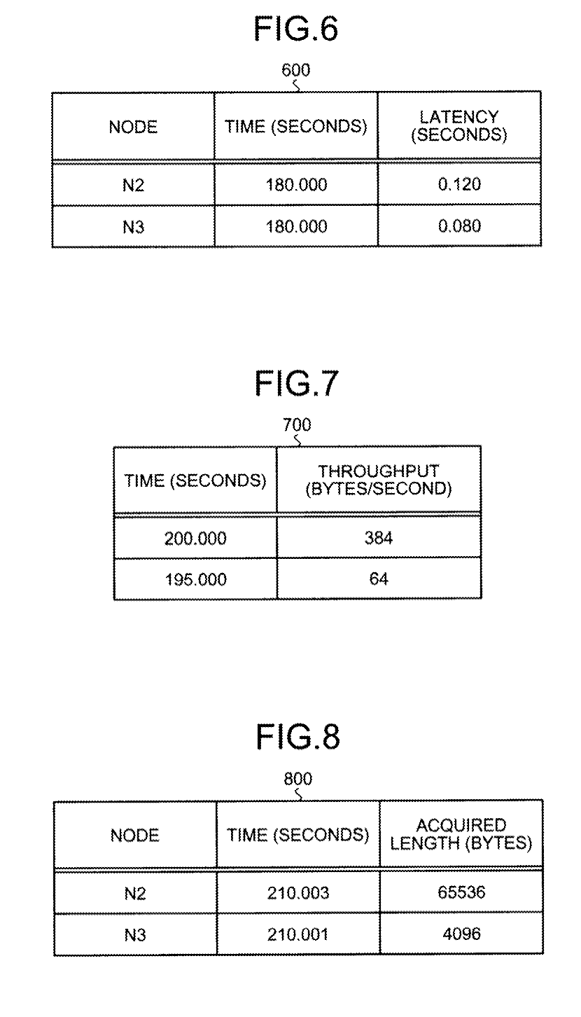

With reference to FIG. 6, the contents of the request token latency log stored in the RAM 303 depicted in FIG. 3 will be described. The request token latency log is a log concerning the time from the transmission of a request token until the acquisition of message M. The source communication apparatus N refers to the request token latency log when determining when to transmit a request token to have an executor communication apparatus N acquire message M before the buffer B becomes exhausted.

FIG. 6 is a diagram depicting the contents of the request token latency log stored in the RAM 303 depicted in FIG. 3. A request token latency log 600 has a node field and a latency field, respectively associated with a time field. In the request token latency log 600, a record for each transmission of a request token is formed and updated at each acquisition of message M.

The time field stores therein the time (seconds) when a request token was transmitted. The node field stores therein the identifier of the executor communication apparatus N to which the request token was transmitted. The latency field stores therein the time from the transmission of the request token until the acquisition of message M.

With reference to FIG. 7, the contents of the source acquisition throughput log stored in the RAM 303 depicted in FIG. 3 will be described. The source acquisition throughput log is a log concerning the message M data volume acquired per unit time and is generated based on the source acquired length log 400. The source communication apparatus N refers to the source acquisition throughput log when determining when to transmit a request token to have an executor communication apparatus N acquire message M before the buffer B becomes exhausted.

FIG. 7 is a diagram depicting the contents of the source acquisition throughput log stored in the RAM 303 depicted in FIG. 3. A source acquisition throughput log 700 has a throughput field associated with a time field, forming a record for each acquisition of message M.

The time field stores therein the time (seconds) when message M was acquired. The throughput field stores therein the message M data volume acquired per unit time (bytes/second) and is calculated by, for example, the current acquired data volume/(the current source acquisition time-the previous source acquisition time).

With reference to FIG. 8, the contents of the acquired length log stored in the RAM 303 depicted in FIG. 3 will be described. The acquired length log is a log concerning the data volume of message M acquired by a given communication apparatus N from another communication apparatus N.

FIG. 8 is a diagram depicting the contents of the acquired length log stored in the RAM 303 depicted in FIG. 3. An acquired length log 800 has a node field and an acquired length field, respectively associated with a time field, forming a record for each acquisition of message M.

The time field stores therein the time (seconds) when message M was acquired. The node field stores therein the identifier of the source communication apparatus N from which message M was acquired. The acquired length field stores therein the acquired message M data volume (bytes).

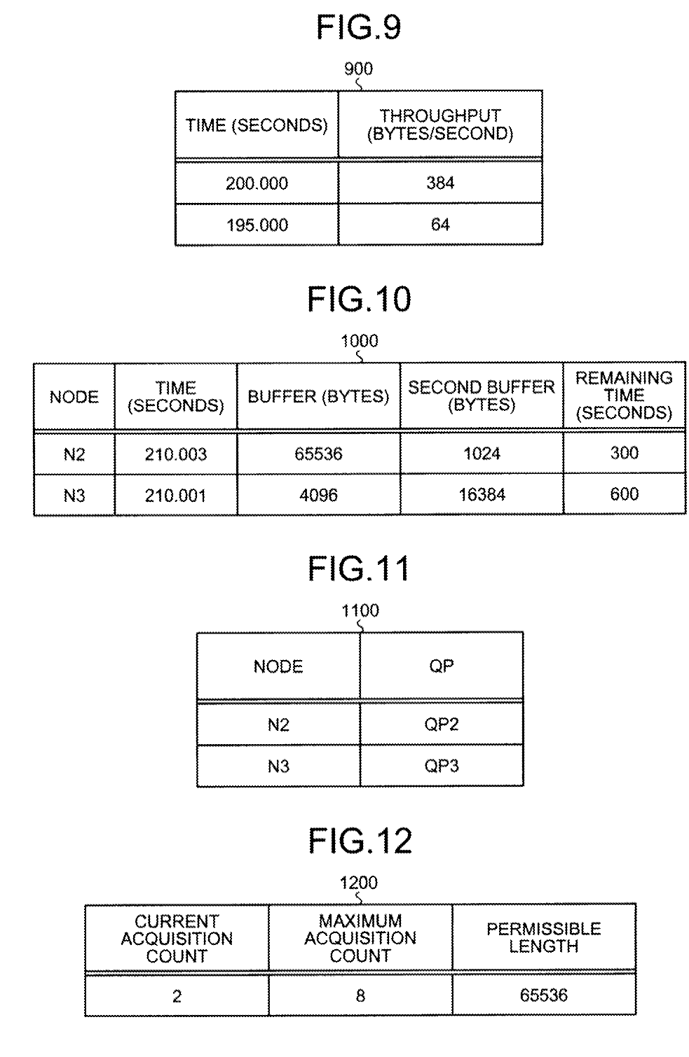

With reference to FIG. 9, the contents of the acquisition throughput log stored in the RAM 303 depicted in FIG. 3 will be described. The acquisition throughput log is a log concerning the message M data volume acquired per unit time, and is generated based on the acquired length log 800. The executor communication apparatus N refers to the acquisition throughput log when determining which source communication apparatus N to give priority as the acquisition target such that the buffer B of the source communication apparatus N does not become exhausted.

FIG. 9 is a diagram depicting the contents of the acquisition throughput log stored in the RAM 303 depicted in FIG. 3. An acquisition throughput log 900 has a throughput field associated with a time field, forming a record for each acquisition of message M.

The time field stores therein the time (seconds) when message M was acquired. The throughput field stores therein the message M data volume acquired per unit time (bytes/second) and can be calculated by, for example, the acquired data volume/(the current acquisition time-the previous acquisition time).

With reference to FIG. 10, the contents of the request token list stored in the RAM 303 depicted in FIG. 3 will be described.

FIG. 10 is a diagram depicting the contents of the request token list stored in the RAM 303 depicted in FIG. 3. A request token list 1000 has a time field, a buffer field, a second buffer field, and a remaining time field, respectively associated with a node field, forming a record for each reception of a request token.

The node field stores therein the identifier of the communication apparatus N that transmitted the request token. The time field stores therein time (seconds) that the request token was received. The buffer field stores therein the data volume (bytes) stored by buffer B that is at the source of the request token and stores message M acquired by the destination (device) of the request token, regarded as an executor of acquisition.

The second buffer field stores therein the data volume (bytes) stored by another buffer B that is different from the buffer B that stores message M acquired by the destination (device) of the request token, regarded as an executor. The remaining time field stores therein the time remaining until the acquisition time limit of message M at the transmission source of the request token.

With reference to FIG. 11, the contents of the communication counterpart list stored in the RAM 303 depicted in FIG. 3 will be described. The communication counterpart list is referred to when the executor communication apparatus N acquires message M or when the source communication apparatus N transmits a request token.

FIG. 11 is a diagram depicting the contents of the communication counterpart list stored in the RAM 303 depicted in FIG. 3. A communication counterpart list 1100 has a QP field associated with a node field, forming a record for each communication apparatus N that is a communication counterpart.

The node field stores therein the identifier of the communication apparatus N that is a communication counterpart. The QP field stores therein an identifier that identifies the QP corresponding to the communication apparatus N.

With reference to FIG. 12, acquisition conditions stored in the RAM 303 depicted in FIG. 3 will be described. The acquisition conditions are stored as a table that concerns the number of communication apparatuses N from which message M can be acquired simultaneously and the upper limit of the data volume that can be acquired, respectively, to an extent that does not pressure the network.

FIG. 12 is a diagram depicting the acquisition conditions stored in the RAM 303 depicted in FIG. 3. An acquisition condition table 1200 has a current acquisition count field, a maximum acquisition count field, and a permissible length field, forming records at initialization processing of the communication apparatus N and updated each time the communication apparatus N begins or ends communication.

The current acquisition count field stores therein the number of communication apparatuses N that are currently acquisition targets. The maximum acquisition count field stores therein the maximum number of communication apparatus N that can be simultaneously subject to acquisition. The permissible length field stores therein the upper limit of the data volume (message M) that can be acquired from a communication apparatus N.

Here, the data volume of message M acquired from each of the source communication apparatuses N is identical. Nonetheless, the data volume of message M to be acquired may differ according to source communication apparatus N. In this case, the acquisition condition table 1200 may have a permissible length field for each source communication apparatus N.

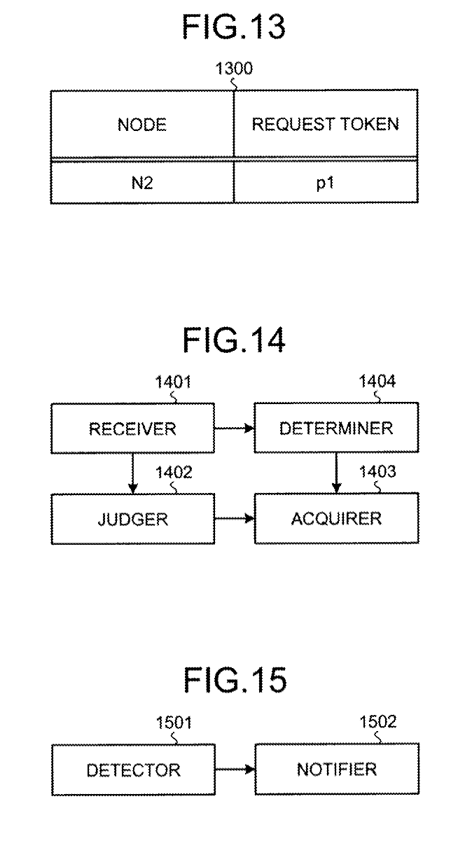

With reference to FIG. 13, the acquisition request list stored in the RAM 303 depicted in FIG. 3 will be described.

FIG. 13 is a diagram depicting the contents of the acquisition request list stored in the RAM 303 depicted in FIG. 3. An acquisition request list 1300 has a request token field associated with a node field, forming a record for each acquisition request registered based on a request token.

The node field stores therein the identifier of the communication apparatus N set to be an acquisition target, from which message M is acquired. The request token field stores therein the identifier of the request token received from the source communication apparatus N set as the acquisition target. The request token identifier is, for example, a pointer to a record in the request token list 1000.

With reference to FIGS. 14 and 15, an example of a functional configuration of the communication apparatus N will be described. Here, for the sake of simplicity, the functions of the communication apparatus N as a source from which message M is acquired and the functions of the communication apparatus N as an executor that acquires message M will be described separately. However, each communication apparatus N may have source and executor functions, respectively.

FIG. 14 is a block diagram of a functional configuration of the communication apparatus N as an executor that acquires message M. Any given communication apparatus N includes a receiver 1401, a judger 1402, an acquirer 1403, and a determiner 1404. These functions (the receiver 1401 to the determiner 1404) forming a controller, for example, are implemented by executing on the CPU 301, a program stored to a storage device such as the ROM 302 and the RAM 303 depicted in FIG. 3, or by the I/F 304.

The receiver 1401 has a function of receiving from any given source among multiple sources, information indicating the data volume of the source data that is at the source and to be acquired by the given communication apparatus N as an executor. Here, a source is a source communication apparatus N. Source data is data that the source communication apparatus N has; is acquired by the given communication apparatus N that is an executor; and is message M.

The data volume is the data volume (buffering volume for the given communication apparatus N) of message M stored in buffer B (buffer B accessed by the given communication apparatus N) storing message M that is to be acquired by the given communication apparatus N. The information indicating the data volume is, for example, an immediate value of the buffering volume for the given communication apparatus N and may include the capacity of the buffer B accessed by the given communication apparatus N. The information indicating the data volume may be a ratio of the capacity of the buffer B accessed by the given communication apparatus N and the buffering volume for the given communication apparatus N.

For example, the receiver 1401 receives a request token that includes the identifier of the source communication apparatus N, and the buffered volume that is at the source communication apparatus N and for the given communication apparatus N. Thus, the receiver 1401 can receive information that is an index for determining the source communication apparatuses N that are to be acquisition targets. The received request token is stored to the request token list 1000 in the RAM 303.

The receiver 1401 has a function of receiving from other sources that are different from the given source, information that indicates the data volume of the source data that is at the other sources and is to be acquired by the given communication apparatus N. For example, the receiver 1401 receives from multiple source communication apparatuses N, request tokens that respectively include the identifier thereof and the buffered volume thereat for the given communication apparatus N. Consequently, the receiver 1401 can receive information that is an index for determining the source communication apparatuses N that are to be acquisition targets.

The receiver 1401 has a function of receiving from the given source, information indicating the data volume of the source data that is at the given source and is to be acquired by another communication apparatus N (as an executor) that is different from the given communication apparatus N. For example, the receiver 1401 receives a request token that includes the data volume (buffered volume for the other communication apparatus N) of message M stored in buffer B (buffer B accessed by the other communication apparatus N) storing message M that is acquired by the other communication apparatus N. Consequently, the receiver 1401 can receive information that is an index for determining the source communication apparatus N that is to be an acquisition target.

The receiver 1401 has a function of receiving from the given source, information related to the acquisition time limit of the source data that is at the given source and is to be acquired by the given communication apparatus N as an executor. For example, the receiver 1401 receives a request token that includes the time remaining until the acquisition time limit of message M that is at the source communication apparatus N and is to be acquired by the given communication apparatus N. Consequently, the receiver 1401 can receive information that is an index for determining the source communication apparatuses N that are to be acquisition targets.

The receiver 1401 has a function of receiving from the other sources, information related to the acquisition time limit of the source data that is at the other sources and is to be acquired by the given communication apparatus N as an executor. For example, the receiver 1401 receives from multiple source communication apparatuses N, request tokens that respectively include the time remaining until the acquisition time limit of message M that is to be acquired by the given communication apparatus N. Consequently, the receiver 1401 can receive information that is an index for determining the source communication apparatuses N that are to be acquisition targets.

The judger 1402 has a function of judging, based on the information received by the receiver 1401, whether a source is to be an acquisition target. When a source is judged to be an acquisition target, a record corresponding to the source (source communication apparatus N) is recorded to the acquisition request list 1300.

For example, the judger 1402 refers to information indicating the data volume of the source data that is at the source and is to be acquired by the given communication apparatus N as an executor and further refers to information indicating the data volume of the source data that is at another source and is to be acquired by the given communication apparatus N. The judger 1402, based on the reference information, judges whether any of the sources are to be an acquisition target.

For instance, based on the buffering volume that is at each source communication apparatus N and for the given communication apparatus N as indicated by the request tokens received from the source communication apparatuses N, the judger 1402 calculates the degree of pressure that the respective buffers B that are at the source communication apparatuses N and accessed by the given communication apparatus N are under. The judger 1402 gives priority to a source communication apparatus N whose buffer B accessed by the given communication apparatus N is under more pressure than that of the other source communication apparatuses N and judges the source communication apparatus N to be an acquisition target. Consequently, message M is preferentially acquired from a source communication apparatus N whose buffer B accessed by the given communication apparatus N is under relatively more pressure, whereby exhaustion of buffer B can be prevented.

For example, the judger 1402 refers to information indicating the data volume of the source data that is at a source and is to be acquired by the given communication apparatus N as an executor and further refers to information indicating the data volume of the source data that is at the source and to be acquired by another communication apparatus N as an executor. The judger 1402, based on the referenced information, judges whether any of the sources are to be an acquisition target.

For instance, in the request token, when the buffering volume for another communication apparatus N is greater than that for the given communication apparatus N, the judger 1402 judges the source communication apparatus N to not be an acquisition target. Consequently, when message M should be preferentially acquired from the source communication apparatus N by another communication apparatus N, the judger 1402 judges to not acquire message M, thereby enabling efficiency over the entire network to be facilitated.

For example, based on information related to the acquisition time limit of the source data that is at a source and to be acquired by the given communication apparatus N as an executor, the judger 1402 judges whether the source is to be an acquisition target. The judger 1402, for example, refers to the time remaining until the acquisition time limit of message M that is at source communication apparatus N and destined to the communication apparatus N, as indicated by the request token. If the time remaining is less than or equal to a threshold, the judger 1402 judges the source communication apparatus N to be an acquisition target. Consequently, even if the buffering volume for the given communication apparatus N is low, if the acquisition time limit is approaching, the source communication apparatus N can be set as an acquisition target.

For example, the judger 1402 refers to information related to the acquisition time limit of the source data that is at a source and is to be acquired by the communication apparatus N as an executor and further refers to information related to the acquisition time limit of the source data that is at another source and to be acquired by the given communication apparatus N as an executor. The judger 1402, based on the referenced information, judges whether any of the sources are to be an acquisition target.

For instance, the judger 1402 refers to the acquisition time limits of message M respectively at multiple source communication apparatuses N and to be acquired by the given communication apparatus N, the acquisition time limits being included in the request tokens received from the source communication apparatuses N. The judger 1402, based on the referenced information, gives priority to a source communication apparatus N whose time remaining until the acquisition time limit is shorter than that of the other source communication apparatuses N and judges the source communication apparatus N to be an acquisition target. Consequently, acquisition targets can be preferentially set from source communication apparatuses N whose acquisition time limits are nearer. Judgment results are stored to a storage area such as the RAM 303.

Further, for example, if the number of acquisition targets being subject to acquisition is greater than or equal to a threshold, the judger 1402 judges that no source is to be an acquisition target. For instance, if among source communication apparatuses N set as acquisition targets, the number of source communication apparatuses N that have not completed acquisition is greater than or equal to a threshold, the judger 1402 judges that a new source communication apparatus N is not to be an acquisition target. Consequently, the data volume on the network is controlled and network congestion is suppressed.

The acquirer 1403 has a function of acquiring from a source judged by the judger 1402 to be an acquisition target, source data that is to be acquired by the given communication apparatus N as an executor. For example, the acquirer 1403 acquires message M from a source communication apparatus N set as an acquisition target. For instance, the acquirer 1403 refers to the communication counterpart list 1100, identifies the QP corresponding to the source communication apparatus N set as an acquisition target, queues an acquisition instruction concerning message M at the identified QP, and causes the HCA to acquire message M. Consequently, message M can be communicated on the network.

The acquirer 1403 has a function of acquiring from a source judged by the judger 1402 to be an acquisition target, the source data of a data volume determined by the determiner 1404. For example, the acquirer 1403 acquires from the source communication apparatus N set as an acquisition target, message M of a data volume determined by the determiner 1404. Consequently, message M can be communicated on the network.

The determiner 1404 has a function of determining, based on the information received by the receiver 1401, the data volume to be acquired from a source judged by the judger 1402 to be an acquisition target. Here, the data volume to be acquired from a source is the acquisition volume described above.

For example, based on the buffering volume for the given communication apparatus N, indicated in the request token, and network throughput, the determiner 1404 determines the data volume of message M to be acquired from a source communication apparatus N such that congestion does occur on the network. The determined data volume of message M is stored to a storage area such as the RAM 303. Consequently, the determiner 1404 can suppress network congestion and determine the data volume that can be acquired.

FIG. 15 is a block diagram of a functional configuration of the communication apparatus N as a source of message M. Any given communication apparatus N includes a detector 1501 and a notifier 1502. These functions (the detector 1501 and the notifier 1502) forming a controller are implemented, for example, by executing, on the CPU 301, program stored in a storage device such as the ROM 302 and the RAM 303 depicted in FIG. 3 or by the I/F 304.

The detector 1501 has a function of detecting that the volume of the source data to be acquired by a given executor is greater than or equal to a threshold. Here, an executor is an executor communication apparatus N described above. The source data is message M acquired by an executor communication apparatus N. The data volume of source data is the data volume of message M in a buffer B storing message M that is to be acquired by an executor communication apparatus N.

For example, the detector 1501 detects that the buffer volume of buffer B is greater than or equal to a threshold. Here, the threshold is a target buffering volume described hereinafter and a value that serves as an index for transmitting a request token before buffer B becomes exhausted so that buffer B does not become exhausted. For example, the threshold is “the capacity of buffer B×safety factor (e.g., 0.6)”. Further, for example, the threshold is “the capacity of buffer B-the average source acquisition throughput×the average request token latency”. Consequently, the detector 1501 can trigger the transmission of a request token before the buffer B becomes exhausted.

The detector 1501 has a function of detecting that the time that has elapsed since the generation of source data has exceeded or is equal to a prescribed period. For example, the detector 1501 starts a timer when message M is generated by an application, measures the time that elapses, and detects that the elapsed time has reached or exceeded a prescribed period. Here, the prescribed period is a deadline described hereinafter and a value that serves as an index for transmitting a request token before the acquisition time limit. The acquisition time limit is the maximum value (maximum allowed latency) of message M latency (the time from the generation of message M until the acquisition thereof) that the application can allow.

For example, the prescribed period is “the maximum allowed latency×safety factor (e.g., 0.6)”. Further, for example, the prescribed period is “the maximum allowed latency-the average request token latency”. Consequently, the detector 1501 can trigger the transmission of a request token before the acquisition time limit of message M.

The detector 1501 has a function of detecting the data volume of source data that is to be acquired by another executor that is different from the given executor. For example, the detector 1501 detects the buffering volume of the buffers B from which multiple executor communication apparatuses N acquire source data, respectively.

The notifier 1502 has a function of the providing to an executor, information indicating the data volume of source data when the data volume of the source data has been detected, by the detector 1501, to have reached or exceeded a threshold. For example, when the buffering volume is greater than or equal to the target buffering volume, the notifier 1502 transmits to the executor communication apparatus N that acquires message M, a request token that includes information indicating the buffering volume. Consequently, a request token that triggers the executor communication apparatus N to acquire message M from the given communication apparatus N can be transmitted to the executor communication apparatus N.

The notifier 1502 has a function of providing to an executor, information indicating the data volume of source data when the elapsed time has been detected, by the detector 1501, to have reached or exceeded the prescribed period. For example, when the elapsed time has reached or passed the deadline, the notifier 1502 transmits to the executor communication apparatus N that acquires message M, a request token that includes information that indicates the buffering volume. Consequently, a request token that triggers the executor communication apparatus N to acquire message M from the given communication apparatus N can be transmitted to the executor communication apparatus N.

The notifier 1502 has a function of providing to an executor, information indicating the data volume of source data and information related to the acquisition time limit of the source data. The information related to the acquisition time limit is, for example, the time that has elapsed since the generation of message M. Further, the information related to acquisition time limit may be, for example, the time remaining until the acquisition time limit. For instance, the notifier 1502 transmits to the executor communication apparatus N, a request token that includes information related to the acquisition time limit. Consequently, information related to the acquisition time limit, which is information serving as an index for determining (at the executor communication apparatus N) an acquisition target, can be provided to the executor communication apparatus N.

The notifier 1502 has a function of providing to an executor, information indicating the data volume of the source data and information indicating the data volume of source data that is acquired by another executor. Here, information indicating the data volume of source data acquired by another executor is, for example, the buffering volume of a buffer B storing therein message M that acquired by another executor communication apparatus N that is different from the destination of the request token. Consequently, information serving as an index for determining, at the executor communication apparatus N, an acquisition target (i.e., the buffering volume of a buffer B storing therein message M that is acquired by another executor communication apparatus N that is different from the destination of the request token) can be provided to the executor communication apparatus N.

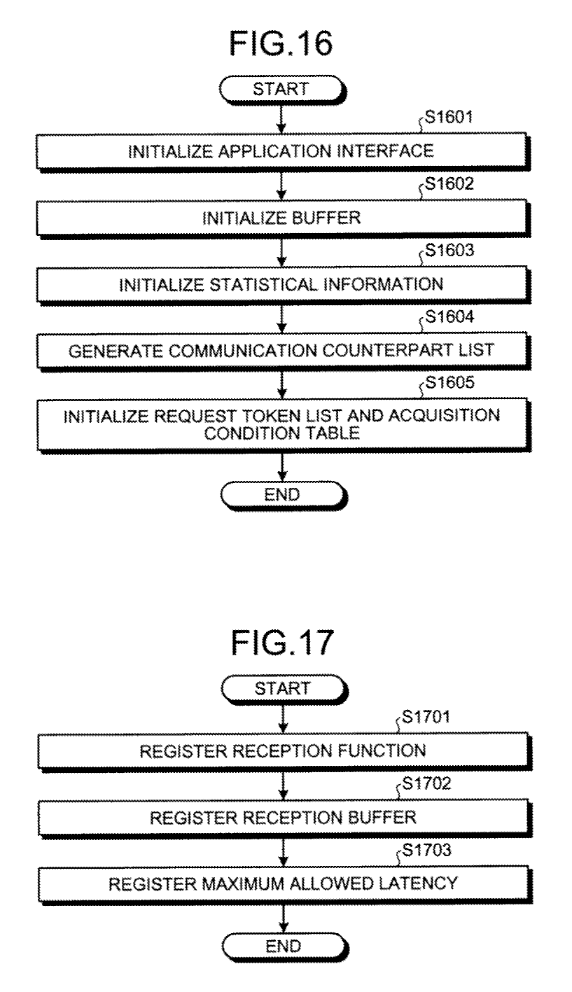

With reference to FIGS. 16 and 17, processing performed as communication preprocessing by the communication apparatus N will be described.

With reference to FIG. 16, initialization processing performed by the communication apparatus N before communication begins will be described.

FIG. 16 is a flowchart of the initialization processing. The CPU 301 initializes the application I/F 307 (step S1601). During the initialization of the application I/F 307, application-use registration processing described herein is performed. The CPU 301 initializes buffer B (step S1602). The CPU 301 initializes statistical information (the source acquired length log 400, the source acquisition throughput log 700, the acquired length log 800, and the acquisition throughput log 900) (step S1603).

The CPU 301 generates the communication counterpart list 1100 (step S1604). The CPU 301 initializes the request token list 1000 and the acquisition condition table 1200 (step S1605), and ends the initialization processing. Consequently, the communication apparatus N is able to begin communication.

With reference to FIG. 17, application-use registration processing performed by the communication apparatus N to provide the acquired message M to an application will be described.

FIG. 17 is a flowchart of the application-use registration processing. The CPU 301 registers a reception function (step S1701). The CPU 301 registers a reception buffer (step S1702).

The CPU 301 registers the maximum allowed latency (step S1703), and ends the application-use registration processing. Consequently, the communication apparatus N is able to provide the acquired message M to an application.

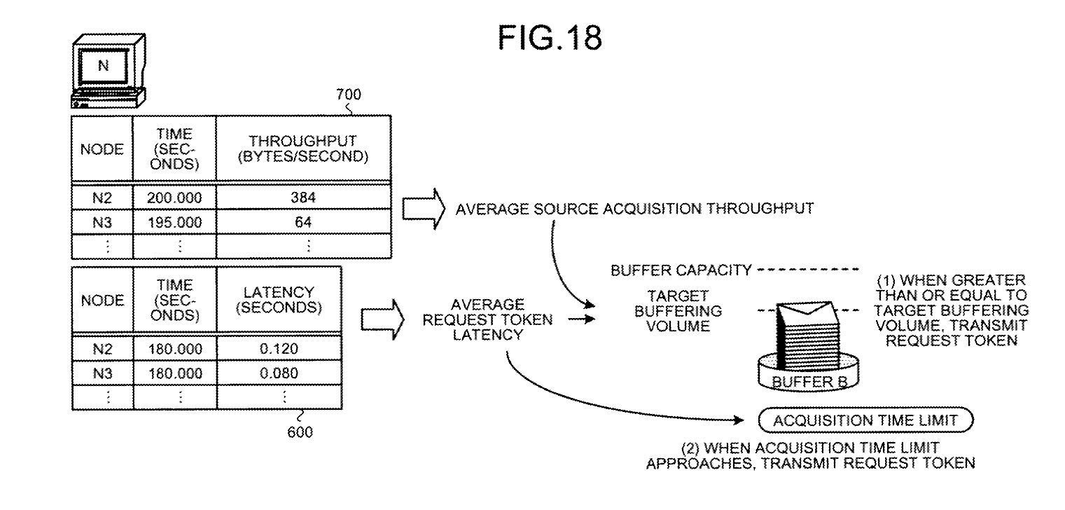

With reference to FIGS. 18 to 20, processing by the source communication apparatus N, e.g., processing by the communication apparatuses N1, N3 depicted in FIG. 1, will be described.

With reference to FIG. 18, the transmission of a request token by a source communication apparatus N will be described.

FIG. 18 is a diagram of request token transmission. The communication apparatus N, such that the buffer B does not become exhausted, calculates a target buffering volume that serves as an index for transmitting a request token before the buffer B becomes exhausted.

Here, the communication apparatus N calculates the average source acquisition throughput based on the source acquisition throughput log 700. The communication apparatus N further calculates the average request token latency based on the request token latency log 600. The communication apparatus N, for example, calculates “the capacity of buffer B-the average source acquisition throughput×the average request token latency” as the target buffering volume.

However, the communication apparatus N may refer to the source acquired length log 400 and the generation log 500 and further adjust the target buffering volume. For example, the communication apparatus N may refer to the source acquired length log 400 and if message M has been frequently acquired in small volumes in the past, may adjust the target buffering volume to be lower so that request token transmission is performed more frequently. Further, the communication apparatus N may refer the generation log 500 and if the application has generated a large volume of message M in the past, may adjust the target buffering volume to be lower.

(1) The communication apparatus N transmits a request token when the buffering volume of the buffer B is greater than the calculated target buffering volume. Consequently, the communication apparatus N triggers the transmission of a request token, enabling a request token to be transmitted to an executor that acquires message M, before the buffer B is exhausted.

The communication apparatus N calculates a deadline that serves as an index for having message M acquired before the acquisition time limit. The acquisition time limit is the maximum value (maximum allowed latency) of message M latency (the time from the generation of message M until the acquisition thereof) that the application can allow. The communication apparatus N calculates, for example “the maximum allowed latency-the average request token latency” as the deadline.

(2) The communication apparatus N measures the time that elapses since the generation of message M and if the elapsed time passes the calculated deadline, transmits a request token. Consequently, the communication apparatus N triggers request token transmission, enabling a request token to be transmitted to the executor that acquires message M, before the acquisition time limit elapses.

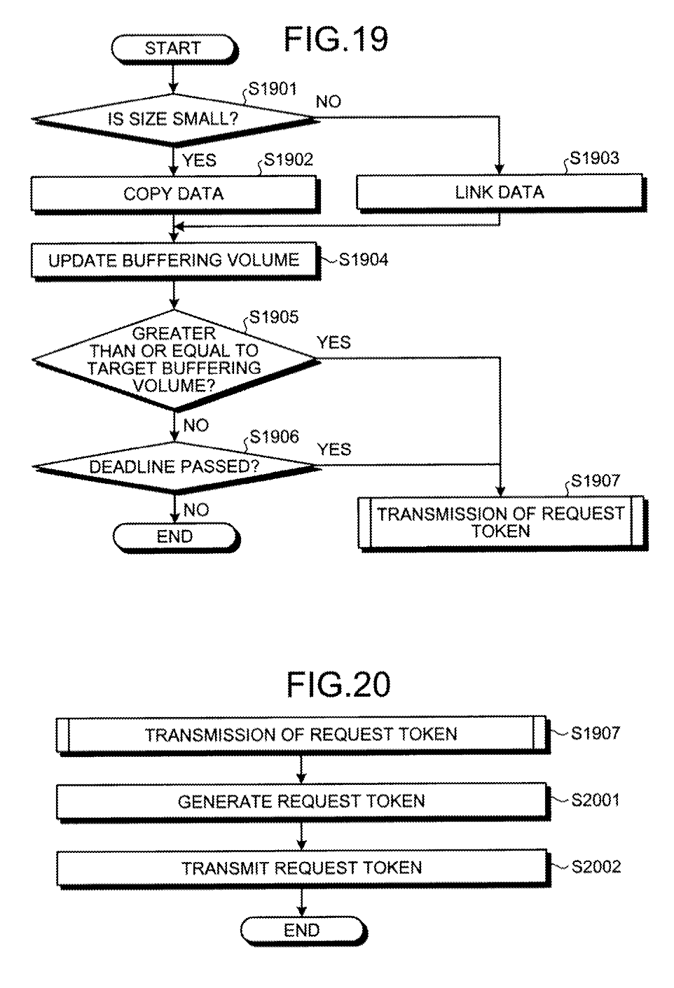

With reference to FIG. 19, buffer management processing by the source communication apparatus N depicted in FIG. 18 and transmitting the request token will be described.

FIG. 19 is a flowchart of the buffer management processing. The CPU 301 judges whether message M generated by an application is of a small size (step S1901). If the size is small (step S1901: YES), the CPU 301 copies message M to buffer B (step S1902), and transitions to step S1904. On the other hand, if the size is large (step S1901: NO), the CPU 301 links message M to buffer B (step S1903), and transitions to step S1904.

The CPU 301 updates the buffer volume of buffer B (step S1904), and judges whether the buffering volume is at least the target buffering volume (step S1905). If the buffering volume is greater than or equal to the target buffering volume (step S1905: YES), the CPU 301 transitions to request token transmission processing (step S1907).

On the other hand, if the buffer volume is less than target buffering volume (step S1905: NO), the CPU 301 judges whether the time that has elapsed since the generation of message M has passed the deadline (step S1906). If the deadline has passed (step S1906: YES), the CPU 301 transitions to the request token transmission processing (step S1907).

On the other hand if the deadline has not passed (step S1906: NO), the CPU 301 ends the buffer management processing. Consequently, request token transmission can be triggered before the capacity of the buffer B falls under pressure. Further, request token transmission can be triggered before the acquisition time limit of message M is passed.

With reference to FIG. 20, the request token transmission processing depicted in FIG. 19 will be described.

FIG. 20 is a flowchart of the request token transmission processing. The CPU 301 generates a request token (step S2001). The CPU 301 transmits the generated request token (step S2002), and ends the request token transmission processing. Consequently, the communication apparatus N can transmit a request token.

Here, the generated request token includes, for example, the identifier of the source communication apparatus N and the data volume of message M stored to a buffer B storing therein message M that is to be acquired by the destination (device) of the request token. Further, the request token may include the data volume of message M that is stored to another buffer B that is different from the buffer B that stores therein message M that is to be acquired by the destination (device) of the request token. The request token may further include information (e.g., the time remaining until the acquisition time limit) related to the acquisition time limit of message M that is acquired by the communication apparatus N that is the destination of the request token and acquires message M.

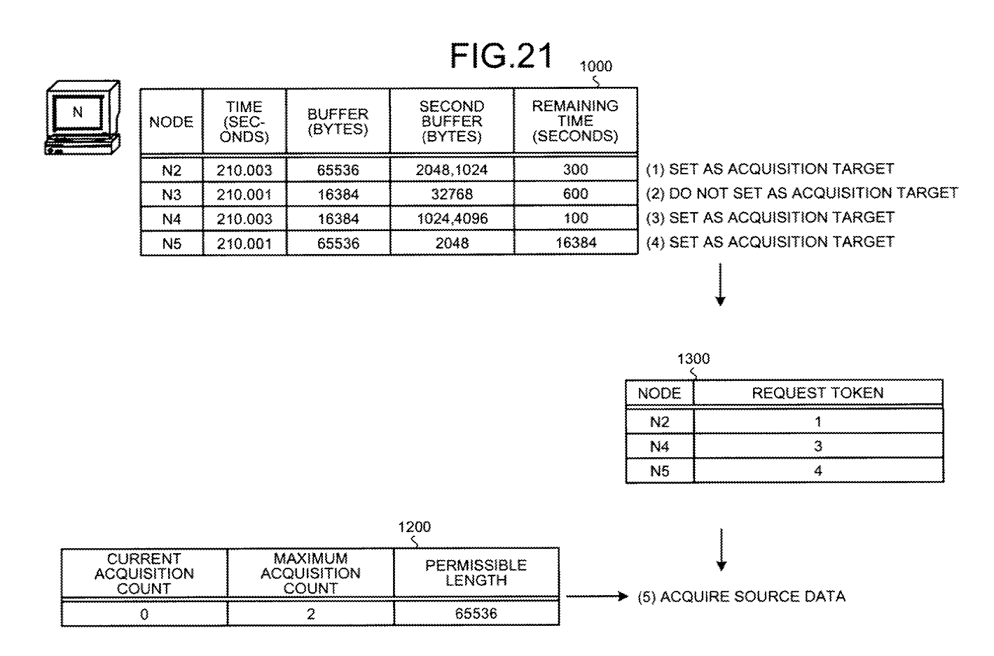

With reference to FIGS. 21 to 23, processing of the communication apparatus N that acquires message M will be described.

With reference to FIG. 21 the acquisition of message M by an executor communication apparatus N that has received a request token will be described. The executor communication apparatus N generates the request token list 1000 from the received request token.

FIG. 21 is a diagram of the acquisition of message M by the executor communication apparatus N that has received a request token. Here, the executor communication apparatus N refers to each record in the request token list 1000 and determines source communication apparatuses N that are to be acquisition targets from which message M is to be acquired. However, the executor communication apparatus N refers to the acquisition condition table 1200 and determines the source communication apparatuses N that are to be acquisition targets to an extent that the maximum acquisition count is not exceeded.

(1) For example, the communication apparatus N adds a record to the acquisition request list 1300 to acquire message M from the communication apparatus N2, which has a large data volume of message M in the buffer B storing message M that is to be acquired by the communication apparatus N.

(2) The communication apparatus N does not yet acquire message M from the communication apparatus N3, whose buffer B is another buffer B that is under pressure and different from the buffer B storing message M that is to be acquired by the communication apparatus N.

(3) The communication apparatus N adds a record to the acquisition request list 1300 to acquire message M from a communication apparatus N4 that has a small data volume of message M in the buffer B storing message M that is to be acquired by the communication apparatus N, but also has little time remaining until the acquisition time limit expires.

(4) The communication apparatus N adds a record to the acquisition request list 1300 to acquire message M from a communication apparatus N5 that has a large data volume of message M in the buffer B storing message M that is to be acquired by the communication apparatus N.

(5) The communication apparatus N, based on the records of the acquisition request list 1300, acquires message M from the communication apparatuses N regarded as acquisition targets. However, the communication apparatus N sets the number of targets of simultaneous acquisition (current acquisition count) to be within the maximum acquisition count indicated in the acquisition condition table 1200. For example, the source communication apparatuses N are set as acquisition targets in the order of record registration in the acquisition request list 1300 and message M is simultaneously acquired from source communication apparatuses N of a number that does not exceed the maximum acquisition count.

Further, for example, source communication apparatuses N may be set as acquisition targets in descending order of the buffering volume indicated in the request tokens corresponding to records in the acquisition request list 1300 and message M may be simultaneously acquired from source communication apparatuses N of a number that does not exceed the maximum acquisition count, thereby enabling message M to be simultaneously acquired from multiple communication apparatuses N to an extent that does not cause congestion on the network.

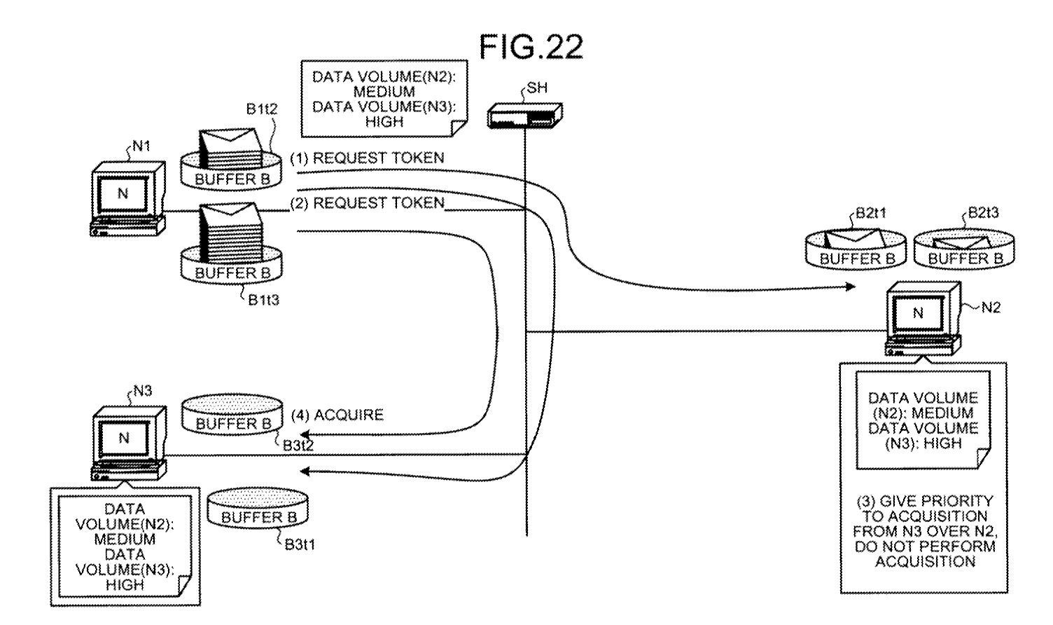

With reference to FIG. 22, message M acquired by the communication apparatus N that has received a request token that indicates the buffering volume for another executor (e.g., the contents of the processing depicted in FIG. 21 as step (2)) will be described.

FIG. 22 is a diagram of message M acquisition based on a request token that includes the buffering volume for another executor. Here, the communication system depicted in FIG. 22 is the same communication system depicted in FIG. 1. Hereinafter, an example where the communication apparatus N1 requests the communication apparatuses N2, N3 to acquire message M buffered in the buffer of the communication apparatus N1 will be given to describe communication by the communication apparatuses N.

In FIG. 22, (1) the communication apparatus N1 transmits a request token to the communication apparatus N2 since message M, which is acquired by the communication apparatus N2, is stored in buffer B1t2

(2) The communication apparatus N1 transmits a request token to the communication apparatus N3 since message M, which is acquired by the communication apparatus N3, is stored in buffer B1t3.

Here, the request tokens include the identifier of the communication apparatus N1, which is the source from which message M is to be acquired; the data volume of message M stored in buffer B1t2; and the data volume of message M stored in buffer B1t3, respectively.

(3) The communication apparatus N2 that has received a request token refers to the data volume of message M stored to buffer B1t2 and the data volume of message M stored to buffer B1t3 indicated in the received request token, and judges whether to acquire message M from the communication apparatus N1.

In this example, the data volume of message M stored to buffer B1t3 is greater than the data volume of message M stored to buffer B1t2. Consequently, the communication apparatus N2 judges that the communication apparatus N1 should have the communication apparatus N3 acquire message M before the communication apparatus N2. The communication apparatus N2 does not yet acquire message M from the communication apparatus N1.

(4) On the other hand, the communication apparatus N3, which has received a request token, refers to the data volume of message M stored to buffer B1t2 and the data volume of message M stored to buffer B1t3 indicated in the received request token, and judges whether to acquire message M from the communication apparatus N1.

In this example, the data volume of message M stored to buffer B1t3 is greater than the data volume of message M stored to buffer B1t2. Consequently, the communication apparatus N3 judges that communication with the communication apparatus N1 should be before communication between the communication apparatus N1 and the communication apparatus N2, and acquires message M from the communication apparatus N1.

Thus, since determination of whether to set a source communication apparatus as an acquisition target is based on the pressure on the buffers B at the sources, efficiency over the entire network can be facilitated rather than efficiency between communication apparatuses N, one-to-one. Further, since message M stored in a buffer B under more pressure is given priority by the executor communication apparatus N, exhaustion of the capacity of the buffer B can be prevented.

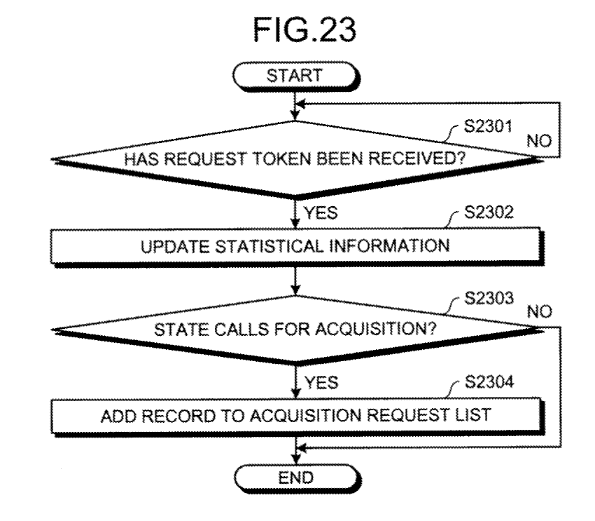

With reference to FIG. 23, acquisition request registration processing performed by the communication apparatus N that has received a request token (e.g., the processing performed by the communication apparatus N2 depicted in FIG. 1) will be described.

FIG. 23 is a flowchart of acquisition request registration processing. The CPU 301 judges whether a request token has been received (step S2301). If a request token has not been received (step S2301: NO), the CPU 301 returns to step S2301 and waits for a request token to be received.

On the other hand, if a request token has been received (step S2301: YES), the CPU 301 updates statistical information (step S2302). The CPU 301 refers to the received request token and judges whether the state calls for acquisition (step S2303). The judgment at step S2303, for example, corresponds to steps (1) to (4) depicted in FIG. 21.

If the state does not call for acquisition (step S2303: NO), the CPU 301 ends acquisition request registration processing. On the other hand, if the state calls for acquisition (step S2303: YES), the CPU 301 refers to the request token, adds a record to the acquisition request list 1300 (step S2304), and ends the acquisition request registration processing.

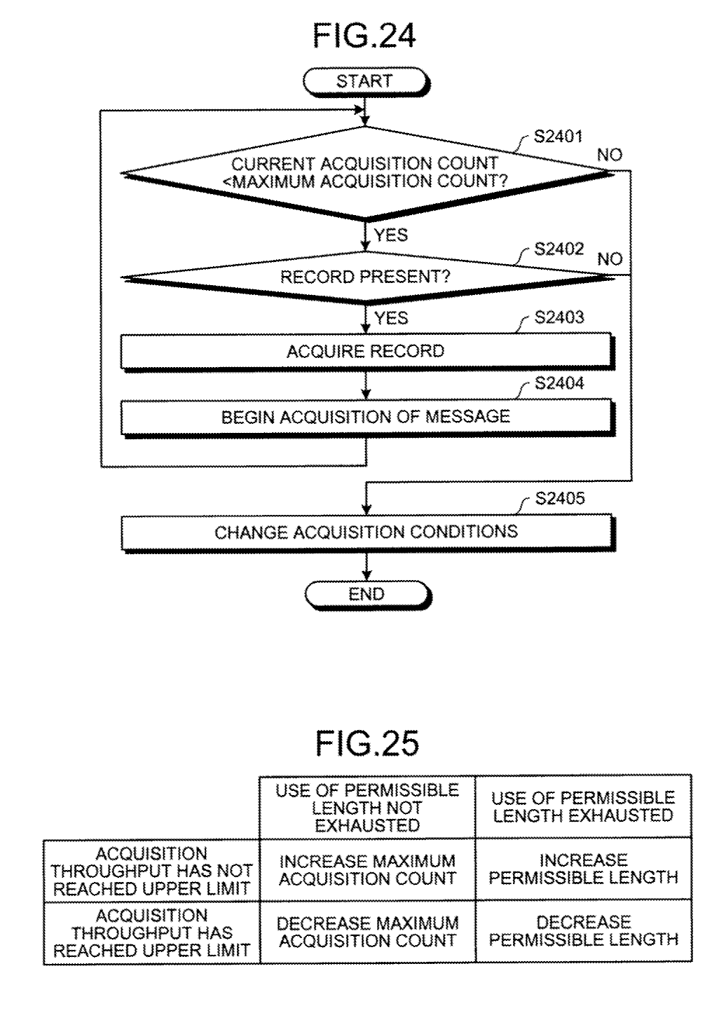

With reference to FIG. 24, acquisition processing performed by the communication apparatus N, based on the acquisition request list 1300 will be described. For example, when the executor communication apparatus N adds a record to the acquisition request list 1300 at step S2304 in FIG. 23 or for each given period, the executor communication apparatus N executes the acquisition processing and acquires message M from a source communication apparatus N.

FIG. 24 is a flowchart of acquisition processing. The CPU 301 judges whether the current acquisition count is less than the maximum acquisition count (step S2401). If the current acquisition count is more than or equal to the maximum acquisition count (step S2401: NO), the CPU 301 transitions to step S2405.

On the other hand, if current acquisition count is less that the maximum acquisition count (step S2401: YES), the CPU 301 judges whether a record is present in the acquisition request list 1300. If no record is present (step S2402: NO), the CPU 301 transitions to step S2405.

On the other hand, if a record is present in the acquisition request list 1300 (step S2402: YES), the CPU 301 acquires any one of the records in the acquisition request list 1300 (step S2403). The CPU 301, based on the acquired record, begins acquisition of message M (step S2404). The CPU 301 returns to step S2401.

At step S2405, the CPU 301 changes the acquisition condition table 1200 (step S2405), and ends the acquisition processing. Thus, the communication apparatus N, within the maximum acquisition count, simultaneously acquires message M from multiple source communication apparatuses N.

The executor communication apparatus N, if message M acquisition has ended, transmits completion notification to the source communication apparatus N. The executor communication apparatus N, if the message M acquisition has ended, deletes the acquisition request list 1300 record that corresponds to the source communication apparatus N set as an acquisition target. Further, the executor communication apparatus N, if acquisition of all of message M in buffer B of the source communication apparatus N has ended, deletes the request token list 1000 record that corresponds to the source communication apparatus N set as an acquisition target. Further, the executor communication apparatus N, if message M acquisition has ended, updates statistical information.

With reference to FIG. 25, changes to the acquisition condition table 1200 at step S2405 will be described. For example, the communication apparatus N, according to the state of network utilization, dynamically changes the acquisition condition table 1200. The acquisition condition table 1200 may be fixed.

FIG. 25 is a diagram depicting changes of the acquisition condition table 1200. The communication apparatus N, as shown in the chart depicted in FIG. 25, changes the acquisition condition table 1200, based on conditions of whether use of the permissible length has been exhausted and whether the acquisition throughput has reached the upper limit.

Here, the upper limit is the product of the limiting value of the acquisition throughput (the acquisition throughput that is the threshold at which congestion occurs on the network) multiplied by a safety factor 0.8 and is an index for avoiding congestion on the network.

For example, if the acquisition throughput has not reached the upper limit and the use of the permissible length has not been exhausted, as the network will not become congested even if the number of source communication apparatuses N subject to simultaneous acquisition is increased, the communication apparatus N increases the maximum acquisition count.

Further, for example, if the acquisition throughput has not reached the upper limit and the use of the permissible length has been exhausted, as the network will not become congested even if the data volume to be acquired at 1 acquisition from the source communication apparatus N is increased, the communication apparatus N increases the permissible length.

Further, for example, if the acquisition throughput has reached the upper limit and use of the permissible length has not be exhausted, the communication apparatus N reduces the number of source communication apparatuses N to be subject to simultaneous acquisition and suppresses network congestion.

Moreover, for example, if the acquisition throughput has reach the upper limit and the use of the permissible length has been exhausted, the communication apparatus N reduces the data volume to be acquired at 1 acquisition from the source communication apparatus N and suppresses network congestion.

Thus, the communication apparatus N dynamically changes the acquisition condition table 1200, according to the utilization state of the network. The acquisition condition table 1200 may include an acquired length field for each source communication apparatus N. The executor communication apparatus N may refer to the acquired length field in the acquisition condition table 1200 and acquire message M by data volumes that differ according to source communication apparatus N.

Further, the executor communication apparatus N may update the acquisition condition table 1200 records, based on information included in the request token received from the source communication apparatus N. For example, when communication begins, the executor communication apparatus N, for each source communication apparatus N, builds a record in the acquisition condition table 1200, each record being set with the same permissible length.

For example, for a source communication apparatus N from which numerous request tokens have been received and the buffering volume indicated by each of the request tokens is large, the executor communication apparatus N increases the data volume indicated by the corresponding permissible length field in the acquisition condition table 1200. Further, for example, for a source communication apparatus N from which few request tokens have been received and the buffering volume indicated by each of the request tokens is small, the executor communication apparatus N decreases the data volume indicated by the corresponding permissible length field in the acquisition condition table 1200.

As described, based on the buffering volume of each of the source communication apparatuses N as indicated by the request tokens from the source communication apparatuses N, the communication apparatus N that is an executor acquires message M from the source communication apparatuses N whose buffer B is under more pressure.

As a result, buffers B at the source communication apparatuses N do not become exhausted, the data volume of message M on the network is managed, collisions of message M are avoided, and congestion can be suppressed. Since congestion can be suppressed, increases in communication time caused by congestion can be avoided and the communication phase of the network overall can be shortened.

The request token includes the buffering volume of multiple buffers B at the source communication apparatus N. Consequently, message M of the buffer B under the most pressure at the source communication apparatus N is given priority and is acquired, enabling exhaustion of the buffer B to be avoided. The executor communication apparatus N determines whether to acquire message M, based on the buffering volumes of the buffers B at the source communication apparatuses N and thereby enables efficiency over the entire network to be facilitated rather than efficiency between communication apparatuses N, one-on-one.

The communication apparatus N can set the number of source communication apparatuses N subject to acquisition at one time to be less than or equal to a threshold, manage the data volume of message M on the network, avoid collisions of message M and suppress congestion.

The request tokens further include information related to the acquisition time limit of message M at the source communication apparatuses N. As a result, the executor communication apparatus N preferentially acquires message M from a source communication apparatus N whose acquisition time limit is close at hand and thus, can acquire message M up to the acquisition time limit.

The executor communication apparatus N determines the upper limit of the data volume of message M to be acquired from the source communication apparatus N and acquires message M. Consequently, the data volume of message M on the network can be managed, collisions of message M can be avoided, and congestion can be suppressed.

At the source communication apparatus N, whether a request token is to be transmitted is judged based on the buffering volume of buffer B. Consequently, the request token is transmitted and message M can be acquired by the executor communication apparatus N before buffer B is exhausted.

At the source communication apparatus N, whether a request token is to be transmitted is further judged based on the acquisition time limit of message M. Consequently, a request token is transmitted and message M can be acquired by the executor communication apparatus N before the acquisition time limit.

Here, in processing fields that use distributed parallel computers such as clusters, communication counterparts are determined depending on calculation results in the course of processing and there are difficult types of processes that preliminarily predict which communication apparatus will be a communication counterpart, such as MapReduce shuffle, Key-Value Storage systems, and Distributed Complex Event Processing.

By algorithms as well as logical and temporal arrangement of communication apparatuses with respect to such difficult processing for preliminarily predicting communication counterparts, a problem arises in that message M communication scheduling, the prevention of collisions, and suppression of congestion cannot be performed. However, the communication apparatus, communication method, and computer product according to the present embodiment are applicable to such difficult processing for preliminarily predicting communication counterparts and, can prevent collisions of message M and suppress congestion.

If message M collision occurs, among technologies suppressing congestion, there is technology that controls Transmission Control Protocol/Internet Protocol (TCP/IP) flow and that prevents Ethernet (registered trade name) collision. Nonetheless, with such technology controlling TCP/IP flow and/or preventing Ethernet (registered trade name) packet collision, a problem arises in that from message M collision until congestion is suppressed, packet loss occurs on the network. A further problem arises in that overhead occurs for control switching by an Ethernet (registered trade name) switch. Consequent to an excess of received data, at the communication apparatus on the reception side, problems of cache miss hits and insufficient memory occur. However, the communication apparatus, communication method, and computer product according to the present embodiment can prevent message M collisions and suppress congestion without the problems of cache miss hits and insufficient memory that occur with technology that controls Transmission Control Protocol/Internet Protocol (TCP/IP) flow and that prevents Ethernet (registered trade name) collision.

The communication method described in the present embodiment may be implemented by executing a prepared program on a computer such as a personal computer and a workstation. The program is stored on a computer-readable medium such as a hard disk, a flexible disk, a CD-ROM, an MO, and a DVD, read out from the recording medium, and executed by the computer. The program may be distributed through a network such as the Internet. However, the computer-readable medium does not include a transitory medium such as a propagation signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication apparatus that communicates with a plurality of sources, the communication apparatus comprising
an interface that receives from a given source among the sources, information indicating a data volume of source data that is at the given source and to be acquired by the communication apparatus as an executor; and
a processor that:
based on the received information, judges whether the given source is to be an acquisition target, and
acquires from the given source that has been judged to be an acquisition target, the source data to be acquired by the communication apparatus.

2. The communication apparatus according to claim 1, wherein
the interface receives from another source that is different from the given source, information indicating the data volume of the source data to be acquired by the communication apparatus and stored at the other source, and
the processor, based on the information from the given source and the information from the other source, judges whether the given source is to be an acquisition target.

3. The communication apparatus according to claim 1, wherein
the interface receives from the given source, information indicating a data volume of source data that is stored at the given source and is to be acquired by another communication apparatus that is different from the communication apparatus, and
the processor, based on the information indicating the data volume of the source data that is to be acquired by the communication apparatus and the information indicating the data volume of the source data that is to be acquired by the other communication apparatus, judges whether the given source is to be an acquisition target.

4. The communication apparatus according to claim 1, wherein
the interface receives from the given source, information related to an acquisition time limit of the source data that is to be acquired by the communication apparatus, and
the processor, based on the information related to the acquisition time limit of the source data that is to be acquired by the communication apparatus judges whether the given source is to be an acquisition target.

5. The communication apparatus according to claim 4, wherein
the interface receives from another source that is different from the given source, information that is related to an acquisition time limit of source data that is stored at the other source and is to be acquired by the communication apparatus, and
the processor, based on the information related to the acquisition time limit of the source information that is stored at the given source and is to be acquired by the communication apparatus and the information related to the acquisition time limit of the source information that is stored at the other source and is to be acquired by the communication apparatus, judges whether the given source is to be an acquisition target.

6. The communication apparatus according to claim 1, wherein
the processor:
based on the received information, determines a data volume that is to be acquired from the given source that has been judged to be an acquisition target, and
acquires from the given source judged to be an acquisition target, the source data of the determined data volume.

7. The communication apparatus according to claim 1, wherein
the processor judges the given source to not be an acquisition target when acquisition targets from which the source data is being acquired, are of a number that is greater than or equal to a threshold.

8. A communication apparatus comprising
a processor that:
detects that data volume of source data that is to be acquired by an executor is greater than or equal to a threshold, and
provides to the executor, information indicating the data volume of the source data, when the data volume of the source data has been detected to be greater than or equal to the threshold.

9. The communication apparatus according to claim 8, wherein
the processor:
detects that time elapsing since generation of the source data exceeds or is equal to a prescribed period, and
provides to the executor, the information indicating the data volume of the source data, when the time elapsing since generation of the source data has been detected to exceed or be equal to the prescribed period.

10. The communication apparatus according to claim 8, wherein
the processor provides to the executor, the information indicating the data volume of the source data and information related to an acquisition time limit of the source data.

11. The communication apparatus according to claim 8, wherein
the processor:
detects the data volume of source data that is to be acquired by another executor that is different from the executor, and
provides to the executor, the information indicating the data volume of the source data that is to be acquired by the executor and information indicating the data volume of the source data that is to be acquired by the other executor.

12. A communication method executed by a communication apparatus that communicates with a plurality of sources, the communication method comprising:
receiving from a given source among the sources, information indicating a data volume of source data that is to be acquired by the communication apparatus as an executor;
judging based on the received information, whether the given source is to be an acquisition target;
acquiring from the given source that has been judged to be an acquisition target, the source data to be acquired by the communication apparatus.

13. A communication method executed by a computer, the communication method comprising:
detecting that data volume of source data that is to be acquired by an executor is greater than or equal to a threshold; and
providing to the executor, information indicating the data volume of the source data, when the data volume of the source data has been detected to be greater than or equal to the threshold.

14. A computer-readable medium storing therein a communication program that causes a communication apparatus, which communicates with a plurality of sources, to execute a process, the process comprising:
receiving from a given source among the sources, information indicating a data volume of source data that is to be acquired by the communication apparatus as an executor;
judging based on the received information, whether the given source is to be an acquisition target;
acquiring from the given source that has been judged to be an acquisition target, the source data to be acquired by the communication apparatus.

15. A computer-readable medium storing therein a communication program that causes a communication apparatus that causes a computer to execute a process, the process comprising:
detecting that data volume of source data that is to be acquired by an executor is greater than or equal to a threshold; and
providing to the executor, information indicating the data volume of the source data, when the data volume of the source data has been detected to be greater than or equal to the threshold.
